(19) United States
(12) Patent Application Publication
(10) Pub. No.: US 2005/0157506 A1
(43) Pub. Date: Jul. 21, 2005

(54) INFIXED TABLE LAMP WITH DISPLACEABLE AND CHANGEABLE NUMBER OF LAMPS

(76) Inventor: Chun-I Chen, Taichung (TW)

Correspondence Address: Wisam Enterprises Co., Ltd., P. O. Box No. 6-57, Junghe, Taipei, 235, TW

(21) Appl. No.: 10/759,041

(22) Filed: Jan. 20, 2004

(51) Int. Cl. F21V 21/00

(52) U.S. Cl. 362/391

(57) ABSTRACT

An infixed table lamp with displaceable and changeable number of lamps, characterized in that: two conducting support tubes are mounted on a base of the table lamp and extend upwards therefrom mutually paralleled. A plurality of lampshades are configured on the conducting support tubes, and the plurality of lampshades utilize an infixing structure configured on a base of each of the lampshades to infix on the conducting support tubes thereof. According to aforementioned structure, the infixing structure is utilized to secure fixing of the lampshades at any position on the conducting support tubes, thereby allowing arbitrary increase or decrease in number of lamp shades on the conducting support tubes. The table lamp thus achieves effectiveness of providing even greater diversification of styles.

### BACKGROUND OF THE INVENTION

(a) Field of the Invention

The present invention relates to an infixed table lamp with displaceable and changeable number of lamps, and more particularly to the table lamp that provides functionality to arbitrarily change number of lamps and positioning of illumination therefrom.

(b) Description of the Prior Art

Accordingly, a table lamp comes in various configurations and designs, and because the table lamp has distinguishing features that appeal to the eye and provide convenience of usage, therefore people like to employ the table lamp as an indoor embellishment, wherewith filling a household with a warm atmosphere. Though the conventional table lamp comes in a multitude of designs, selection can only be made among a few personal preferences. Furthermore, upon initial purchase, the table lamp endows the household with artistic pleasure, however passing of time benumbs any feeling towards the table lamp, and thus the table lamp loses artistic appeal. Moreover, designs of conventional table lamps are fixed, and therefore very difficult to transform original design structure of the conventional table lamp. Only by repurchasing another table lamp of different design can demands be satisfied, which in consequence bring about an increase in monetary expenses.

Furthermore, because designs of conventional table lamps are all of fixed type, altering angle of light bulb illumination or number of light bulbs is made impossible, and effectively disallows adjusting direction of rays of light cast and number of light beams to complement indoor furnishing arrangement, thus besetting a user with vexation.

### SUMMARY OF THE INVENTION

In light of aforementioned shortcomings of a conventional table lamp, the inventor of the present invention, having accumulated years of professional experience engaged in related art, has undertaken attentive and circumspect research to finally design a completely new infixed table lamp with displaceable and changeable number of lamps.

A primary objective of the present invention is to provide the table lamp that provides functionality to arbitrarily change number of lamps and positioning of illumination therefrom.

To achieve aforesaid objective, the table lamp with displaceable and changeable number of lamps of the present invention primarily comprises a configuration whereby two conducting support tubes are mounted on a base of the table lamp and extend upwards therefrom mutually paralleled. A plurality of lampshades are configured on the conducting support tubes, and utilize an infixing structure configured on a base of each of the lampshades to infix on the conducting support tubes. Moreover, a light bulb is fitted within each of the plurality of lampshades.

According to aforementioned structure, the infixed table lamp with displaceable and changeable number of lamps utilizes the infixing structure to secure fixing of the lampshades at any position on the conducting support tubes, and thereby enables altering angle of illumination of the lamps thereat, as well as arbitrary increasing or decreasing in number of lamp shades on the conducting support tubes. The table lamp thus achieves effectiveness of providing even greater diversification of styles.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according to the present invention.

FIG. 2 shows a schematic elevational view of fitting of lampshades according to the present invention.

FIG. 3 shows a schematic cross sectional view of fitting of the lampshades according to the present invention.

FIG. 4 shows a schematic cross sectional view after fitting of the lampshades according to the present invention.

FIG. 5 shows an elevational view of another embodiment according to the present invention.

FIG. 6 shows an elevational view of yet another embodiment according to the present invention.

### DETAILED DESCRIPTION OF THE PREFERRED EMBODIMENTS

Structure, installation and characteristics of preferred, feasible embodiments of the present invention are disclosed in the following detailed description in conjunction with accompanying drawings:

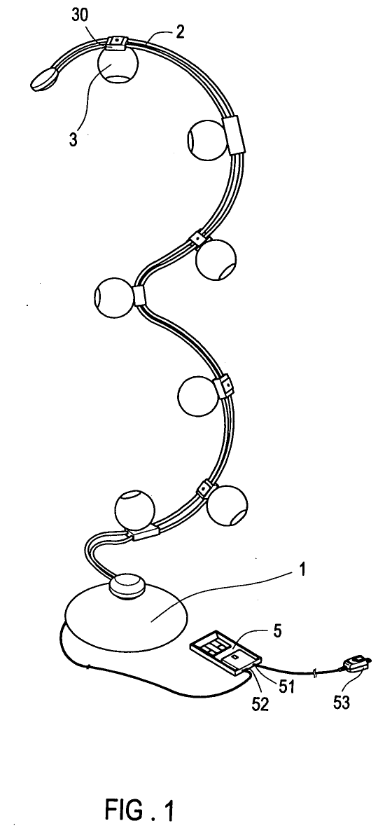

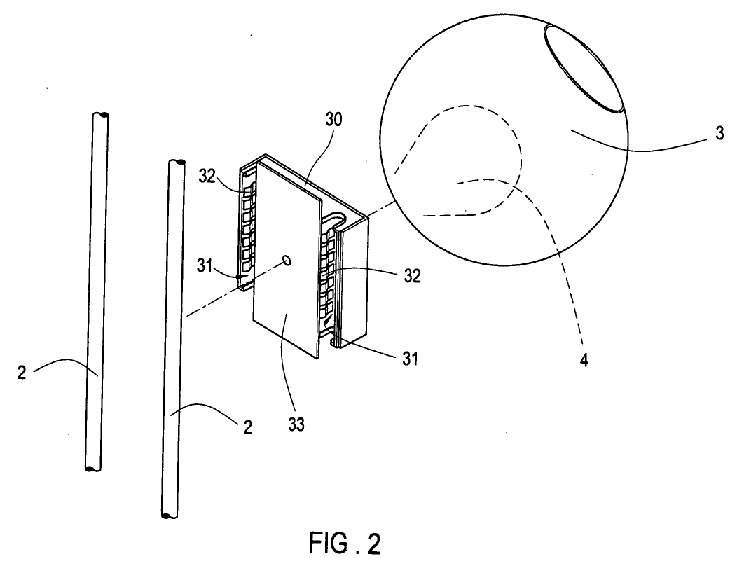

Referring to FIGS. 1 and 2, which show an infixed table lamp with displaceable and changeable number of lamps of the present invention primarily structured to comprise a base 1, a dimmer 5 and a plurality of lampshades 3. A light bulb 4 is fitted within each of the plurality of lampshades 3, and the dimmer 5 is provided with a voltage input terminal 51 and a voltage output terminal 52. A plug 53 is connected to the voltage input terminal 51, and utilized to plug into a power outlet. The present invention is characterized in that:

Two conducting support tubes 2 are mounted on the base 1 and extend upwards therefrom mutually paralleled. The conducting support tubes 2 connect to the voltage output terminal 52 of the dimmer 5. An infixing mount 30 is configured on a base of each of the plurality of lampshades 3. Infixing grooves 31 are respectively defined in two sides of a bottom surface of each of the infixing mounts 30, and which are configured so as to correspond with the conducting support tubes 2. Conducting terminals 32 are configured within each of the infixing grooves 31, and the conducting terminals 32 connect to a voltage input terminal of each of the light bulbs 4 configured within the lampshades 3. A fixing piece 33 is further configured on a base of each of the infixing mounts 30, and adapted to allow rotating thereof.

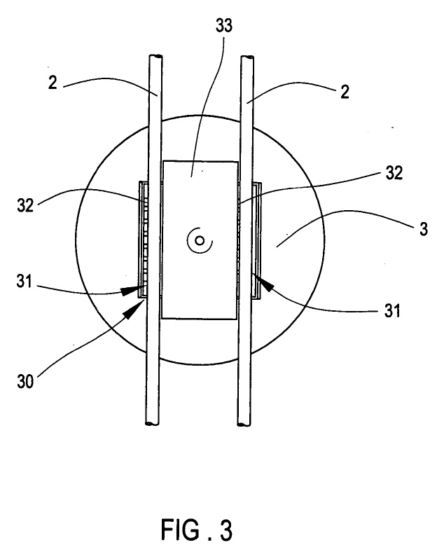

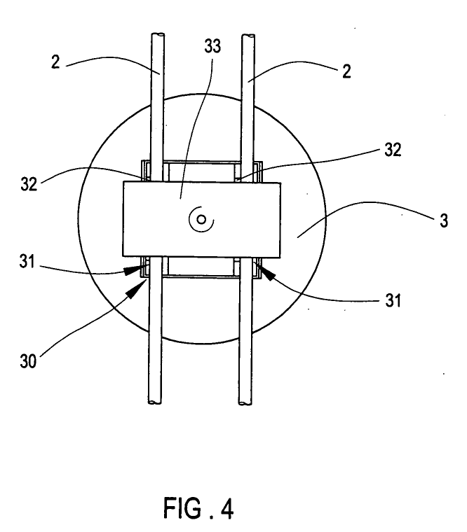

According to aforementioned structure, upon using the infixed table lamp with displaceable and changeable number of lamps, the plug 53 is plugged into the power outlet, thereby enabling electricity to flow into the voltage input terminal 51 of the dimmer 5, thereupon the dimmer 5 converts power input voltage to low voltage electricity of 12V, and outputs same through the voltage output terminal 52. Because of the connection between the voltage output terminal 52 and the conducting support tubes 2, the 12V electricity thus flows through the conducting support tubes 2. Thereafter, the conducting support tubes 2 are inset into the infixing grooves 31 defined in the base of each of the lampshades 3 (see FIG. 3). The fixing pieces 33 are then rotated 90 degrees over the conducting support tubes 2, thereby closing openings of the infixing grooves 31 (see FIGS. 3 and 4), and the lampshades 3 are thus fixed securely onto the conducting support tubes 2. The low voltage electricity flowing in the conducting support tubes 2 is accordingly enabled to flow into the voltage input terminals of the light bulbs 4 by means of the conducting terminals 32, thereby causing light to emit from the light bulbs 4 thereof.

As above said, because the lampshades 3 utilize the infixing grooves 31 to realize secure fixing on the conducting support tubes 2, therefore a user can freely move the lampshades 3 to differing positions on the conducting support tubes 2 according to notion of the user. Thus, the infixed table lamp with displaceable and changeable number of lamps is provided with functionality to adjust a plurality of light beams to a wide variety of differing angles and positions.

Furthermore, number of the lampshades 3 on the conducting support tubes 2 can be arbitrarily increased or decreased, thereby enabling the infixed table lamp with displaceable and changeable number of light bulbs to achieve visionary effectiveness of kaleidoscopic changes.

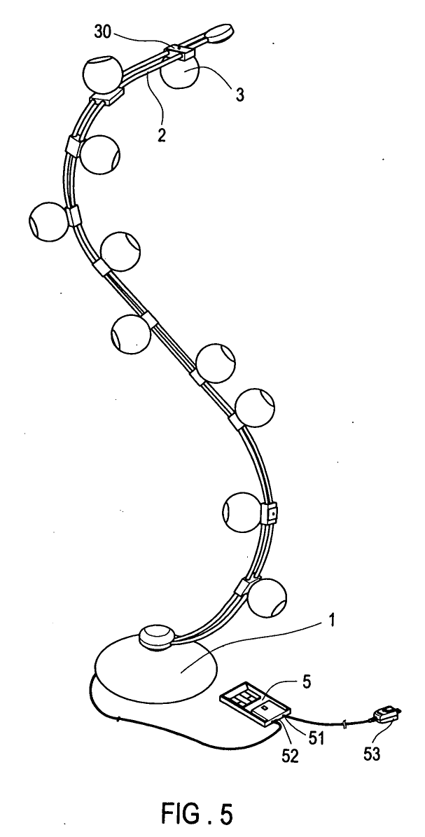

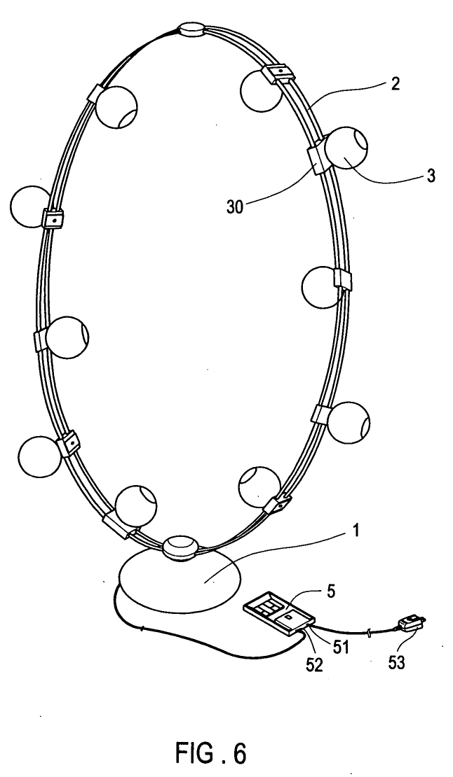

Referring to FIGS. 5 and 6, which show form of the conducting support tubes 2 of the infixed table lamp with displaceable and changeable number of lamps fashioned so as to form a S-shape, and an O-shape respectively. While not confining the present invention to such forms, the conducting support tubes 2 can be shaped into other forms, thereby realizing a variety of designs and creating differing embodiments therefrom. Thus, the present invention achieves effectiveness of providing even greater diversification of styles.

In conclusion, the infixed table lamp with displaceable and changeable number of light bulbs of the present invention assuredly achieves effectiveness of providing a table lamp with displaceable and changeable number of lamps, and thus a diversification of styles, as well as realizing practicability and advancement of a new invention. Accordingly, a patent application is hereby proposed.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An infixed table lamp with displaceable and changeable number of lamps comprising: a base, a dimmer and a plurality of lampshades; a light bulb is fitted within each of the plurality of lampshades, and the dimmer is provided with a voltage input terminal and a voltage output terminal, a plug is connected to the voltage input terminal, and utilized to plug into a power outlet; and is characterized in that:
conducting support tubes are mounted on the base and extend upwards therefrom mutually paralleled, the conducting support tubes connect to the voltage output terminal of the dimmer; an infixing mount is configured on a base of each of the plurality of lampshades, and infixing grooves are respectively defined in two sides of a bottom surface of each of the infixing mounts, with the infixing grooves so configured to correspond with the conducting support tubes;
conducting terminals are configured within each of the infixing grooves, and the conducting terminals connect to a voltage input terminal of each of the light bulbs configured within the lampshades.

2. The infixed table lamp with displaceable and changeable number of lamps according to claim 1, wherein a fixing piece is configured on a base of each of the infixing mounts, and adapted to allow rotating thereof.

3. The infixed table lamp with displaceable and changeable number of lamps according to claim 1, wherein the conducting support tubes are separately fashioned so as to form a S-shape.

4. The infixed table lamp with displaceable and changeable number of lamps according to claim 1, wherein the conducting support tubes are separately fashioned so as to form an O-shape.
